(19) United States
(12) Patent Application Publication
(10) Pub. No.: US 2024/0419187 A1
(43) Pub. Date: Dec. 19, 2024

(54) ROBOT CONTROL METHOD AND APPARATUS, AND STORAGE MEDIUM

(71) Applicant: MIDEA ROBOZONE TECHNOLOGY CO., LTD., SUZHOU (CN)

(72) Inventors: Tao SUN, SUZHOU (CN); Zhipeng ZHANG, SUZHOU (CN); Wenqi JU, SUZHOU (CN); Quanfei XU, SUZHOU (CN)

(21) Appl. No.: 18/704,896

(22) PCT Filed: Dec. 7, 2021
(86) PCT No.: PCT/CN2021/136031

§ 371 Date: Jun. 5, 2024

(30) Foreign Application Priority Data
Oct. 26, 2021 (CN) 202111248999.8

(51) Int. Cl. G05D 1/622; A47L 11/40; G05D 1/243; G05D 101/15; G05D 105/10; G06T 7/73; G06V 10/77; G06V 10/82; G06V 20/58; G06V 40/10

(52) U.S. Cl. CPC G05D 1/622; A47L 11/4011; A47L 11/4061; G05D 1/243; G06T 7/73; G06V 10/7715; G06V 10/82; G06V 20/58; G06V 40/10; A47L 2201/04; G05D 2101/15; G05D 2105/10; G06T 2207/10016; G06T 2207/20081; G06T 2207/20084; G06T 2207/30196

(57) ABSTRACT

Provided are a robot control method and apparatus, and a storage medium. The robot control method includes: detecting whether a first scene image captured by a camera of a robot includes a foot; obtaining, in response to detecting the foot in multiple consecutive frames of first scene images, multiple frames of second scene images captured by the camera; and recognizing a foot posture based on the multiple frames of second scene images, and controlling the robot based on a control manner corresponding to the recognized foot posture. In a scene image captured by the camera mounted at the robot, when the foot is captured within a field of view, the foot posture is recognized using a video captured by the camera. Intelligent control of the robot is realized based on the recognized foot posture.

### CROSS-REFERENCES TO RELATED APPLICATIONS

The present disclosure is a national phase application of International Application No. PCT/CN2021/136031, filed on Dec. 7, 2021, which claims priority to Chinese patent application No. 202111248999.8, filed on Oct. 26, 2021, the entire contents of which are hereby incorporated by reference.

### FIELD

The present disclosure relates to the field of robot technologies, and more particularly, to a method, an apparatus, and storage medium for robot control.

### BACKGROUND

With the development of science and technology, more and more robots are used in people's daily lives, such as common sweeping robots and mopping robots and more advanced robot housekeepers. Applications of these robots in the household make people's lives more comfortable and convenient. Machine vision as an aid can help robots obtain information about scenes within fields of view of the robots.

At present, control of operations of a robot is mainly based on an application on a mobile phone or buttons on a machine body of the robot.

However, the usage of the application on the mobile phone relies heavily on the mobile phone and a network that is used to transmit control instructions. Thus, the usage of the application is inconvenient and not fast enough. In addition, the buttons on the machine body of the robot have limited functions. Therefore, conventional robot control approaches based on the application on the mobile phone or the buttons on the machine body of the robot are relatively complicated and cumbersome, resulting in poor user experience.

### SUMMARY

An object of the present disclosure is to provide a robot control method and apparatus, and a storage medium to overcome the above-mentioned defects in the related art. The object is realized by the following embodiment.

In one embodiment of the present disclosure, a robot control method is provided. The method includes: obtaining a first scene image of a robot, and detecting whether the first scene image includes a foot; obtaining multiple frames of second scene images of the robot consecutively in response to detecting the foot in a predetermined quantity of consecutive frames of first scene images; and recognizing a foot posture based on the multiple frames of second scene images, and controlling the robot based on a control manner corresponding to the recognized foot posture.

In some embodiments of the present disclosure, the detecting whether the first scene image includes the foot includes: inputting the first scene image into a trained first neural network model, the first neural network model being configured to detect whether the first scene image includes the foot, and output a detection result.

In some embodiments of the present disclosure, the method further includes a training process of the first neural network model, the training process including: obtaining an image, captured by the camera, containing the foot as a positive sample, and obtaining an image, captured by the camera, without the foot as a negative sample; and obtaining the first neural network model by training a pre-established classification model using the positive sample and the negative sample.

In some embodiments of the present disclosure, the recognizing the foot posture based on the multiple frames of second scene images includes: inputting the multiple frames of second scene images that are obtained consecutively into a trained second neural network model, and recognizing the foot posture by the second neural network model based on the multiple frames of second scene images.

In some embodiments of the present disclosure, the recognizing the foot posture by the second neural network model based on the multiple frames of second scene images includes: obtaining multiple frames of feature maps by performing, using a feature extraction module in the second neural network model, a feature extraction sequentially on the multiple frames of second scene images; obtaining, by a temporal shift module in the second neural network model, the multiple frames of feature maps from the feature extraction module, and obtaining multiple frames of shifted feature maps by performing, using the temporal shift module in the second neural network model, a temporal shift on each of the multiple frames of feature maps; and obtaining, by a recognition module in the second neural network model, the multiple frames of shifted feature maps from the temporal shift module, obtaining, by the recognition module in the second neural network model, the multiple frames of feature maps from the feature extraction module, and recognizing, by the recognition module in the second neural network model, the foot posture based on the multiple frames of shifted feature maps and the multiple frames of feature maps.

In some embodiments of the present disclosure, the obtaining the multiple frames of shifted feature maps by performing, using the temporal shift module in the second neural network model, the temporal shift on each of the multiple frames of feature maps includes: for each of frames of feature maps ranging from a first frame of feature map to a penultimate frame of feature map in the multiple frames of feature maps, shifting features of part of channels in the feature map to corresponding channels of a successively subsequent frame of feature map to obtain the multiple frames of shifted feature maps.

In some embodiments of the present disclosure, the recognizing, by the recognition module in the second neural network model, the foot posture based on the multiple frames of shifted feature maps and the multiple frames of feature maps includes: performing, by a convolutional layer in the recognition module, a convolution operation on each of the multiple frames of shifted feature maps; obtaining, by a merging layer in the recognition module, each of multiple frames of convolved feature maps from the convolutional layer, and obtaining multiple frames of merged feature maps by merging, by the merging layer in the recognition module, each of the multiple frames of convolved feature maps with a corresponding one of the multiple frames of feature maps; and obtaining, by a fully connected layer in the recognition module, the multiple frames of merged feature maps from the merging layer, and obtaining, by the fully connected layer in the recognition module, a foot posture recognition result based on the multiple frames of merged feature maps.

In some embodiments of the present disclosure, the obtaining the multiple frames of feature maps by performing, using the feature extraction module in the second neural network model, the feature extraction sequentially on the multiple frames of second scene images includes obtaining the multiple frames of feature maps by performing, using a convolutional module with an attention enhancement mechanism in the feature extraction module, the feature extraction sequentially on the multiple frames of second scene images.

In some embodiments of the present disclosure, the convolutional module with the attention enhancement mechanism includes an attention module arranged between at least one pair of adjacent convolutional layers. The attention module includes a channel attention module, a first fusion layer, a spatial attention module, and a second fusion layer. The method further includes: obtaining, by the channel attention module, a channel weight based on a feature map outputted by a previous convolutional layer; obtaining a first fusion feature map by fusing, by the first fusion layer, the channel weight to the feature map outputted by the previous convolutional layer; obtaining, by the spatial attention module, a spatial position weight based on the first fusion feature map outputted by the first fusion layer; and obtaining a second fusion feature map by fusing, by the second fusion layer, the spatial position weight to the first fusion feature map, and inputting, by the second fusion layer, the second fusion feature map to a next convolutional layer.

In some embodiments of the present disclosure, the method further includes a training process of the second neural network model, the training process including: obtaining multiple video segments each containing the foot that are captured by the camera, and labeling a predetermined foot posture contained in each of the multiple video segments; and obtaining the second neural network model by training a pre-established action recognition model using multiple labeled video segments.

In some embodiments of the present disclosure, subsequent to the obtaining the second neural network model, the method further includes: performing an integer quantization on at least one model parameter of the second neural network model.

In some embodiments of the present disclosure, the controlling the robot based on the control manner corresponding to the recognized foot posture includes: controlling, based on the recognized foot posture being a first predetermined posture, the robot to initiate a cleaning mode to start cleaning; controlling, based on the recognized foot posture being a second predetermined posture, the robot to stop cleaning; controlling, based on the recognized foot posture being a third predetermined posture, the robot to access a target-tracking mode; and controlling, based on the recognized foot posture being a fourth predetermined posture, the robot to perform cleaning in a predetermined range around a position of the foot.

In one embodiment of the present disclosure, a robot control apparatus is provided. The apparatus includes a memory, a processor, and a computer program stored on the memory and executable on the processor. The processor is configured to implement, when executing the computer program, the steps of the method in the above-mentioned embodiments.

In one embodiment of the present disclosure, a robot is provided. The robot includes: the robot control apparatus in the above-mentioned embodiments; and a camera configured to capture a scene image of the robot.

In one embodiment of the present disclosure, a computer-readable storage medium is provided. The computer-readable storage medium has a computer program stored thereon. The program, when executed by a processor, implements the steps of the method in the above-mentioned embodiments.

Based on the robot control method, the robot control apparatus, and the storage medium in the above-mentioned embodiments, embodiments of the present disclosure provide the following advantageous effects or advantages.

In a scene image captured by the camera mounted at the robot, when the foot is captured within a field of view of the robot, a specific foot posture is recognized using a video captured by the camera. Therefore, intelligent control of the robot is realized based on the recognized foot posture. Compared with a conventional control method based on an application on a mobile phone or pressing buttons on a machine body of the robot, the method provided in this disclosure is more convenient, efficient, and intelligent, which can greatly improve user experience. In addition, since the intelligent control can be realized using an existing camera of the robot, intelligent control of a product can be realized without additional costs, which further improves the user experience.

### BRIEF DESCRIPTION OF THE DRAWINGS

The accompanying drawings are merely used for the purpose of illustrating the embodiments, and should not be construed as a limitation on the present disclosure. Moreover, the same components are indicated by the same reference signs throughout the accompanying drawings.

FIG. 1 is a schematic structural view of a robot illustrated in the present disclosure.

FIG. 2 is a schematic flowchart illustrating a robot control method according to an exemplary embodiment of the present disclosure.

FIG. 3 is a schematic flowchart illustrating a foot posture recognition performed by a second neural network model according to the embodiment illustrated in FIG. 2 of the present disclosure.

FIG. 4 is a schematic structural diagram of a second neural network model according to the embodiment illustrated in FIG. 3 of the present disclosure.

FIG. 5 is a schematic structural diagram of an attention module in a feature extraction module according to the embodiment illustrated in FIG. 3 of the present disclosure.

FIG. 6 is a schematic diagram illustrating a shift principle of a temporal shift module according to the embodiment illustrated in FIG. 3 of the present disclosure.

FIG. 7 is a schematic structural diagram of a recognition module according to the embodiment illustrated in FIG. 3 of the present disclosure.

FIG. 8 is a specific flowchart illustrating a robot control method according to an exemplary embodiment of the present disclosure.

FIG. 9 is a schematic structural diagram of a robot control apparatus according to an exemplary embodiment of the present disclosure.

FIG. 10 is a schematic structural diagram of a storage medium according to an exemplary embodiment of the present disclosure.

Embodiments of the present disclosure will be further described with reference to the accompanying drawings and in conjunction with the embodiments.

### DETAILED DESCRIPTION OF THE DISCLOSURE

Embodiments of the present disclosure will be described clearly and completely below in combination with accompanying drawings of the embodiments of the present disclosure. Apparently, the embodiments described below are only a part of the embodiments of the present disclosure, rather than all embodiments of the present disclosure.

It should be noted that all directional indications (such as up, down, left, right, front, rear, etc.) in the embodiments of the present disclosure are only used to explain relative positions between various components, movements of various components, or the like under a predetermined posture (as illustrated in the figures). When the predetermined posture changes, the directional indications also change accordingly.

In addition, in the present disclosure, descriptions associated with “first”, “second”, or the like are only used for descriptive purposes, and cannot be understood as indicating or implying relative importance or implicitly indicating the number of indicated features. Therefore, the features associated with “first” and “second” may explicitly or implicitly include at least one of the features. In the description of the present disclosure, “plurality” means at least two, unless otherwise specifically defined.

In the present disclosure, unless otherwise clearly stipulated and limited, terms such as “connect”, “fix”, or the like should be understood in a broad sense. For example, “fix” may mean a fixed connection or a detachable connection or connection as one piece; mechanical connection or electrical connection; direct connection or indirect connection through an intermediate; or internal communication of two components or the interaction relationship between two components, unless otherwise clearly limited. Specific meanings of the above-mentioned terms in the present disclosure can be understood according to specific circumstances.

In addition, combinations can be performed on the various embodiments of the present disclosure. When a combination of the technical solutions is contradictory or unattainable, the combination of the technical solutions neither exists nor falls within the protection scope of the appended claims of the present disclosure.

To solve a current problem of inconvenience caused by controlling a robot using an application on a mobile phone or buttons on a machine body of the robot, an improved robot control method is provided according to the present disclosure. In particular, a first scene image captured by a camera of a robot is obtained. Whether the first scene image includes a foot is detected. Multiple frames of second scene images captured by the camera are obtained consecutively in response to detecting the foot in a predetermined quantity of consecutive frames of first scene images. Therefore, a foot posture is recognized based on the multiple frames of second scene images. The robot is controlled based on a control manner corresponding to the recognized foot posture.

The following effects can be achieved based on the above description.

In a scene image captured by the camera mounted at the robot, when the foot is captured within a field of view of the robot, a specific foot posture is recognized using a video captured by the camera. Therefore, intelligent control of the robot is realized based on the recognized foot posture. Compared with a conventional control method based on an application on a mobile phone or pressing buttons on a machine body of the robot, the method provided in this disclosure is more convenient, efficient, and intelligent, which can greatly improve user experience. In addition, since the intelligent control can be realized using an existing camera of the robot, intelligent control of a product can be realized without additional costs, which further improves the user experience.

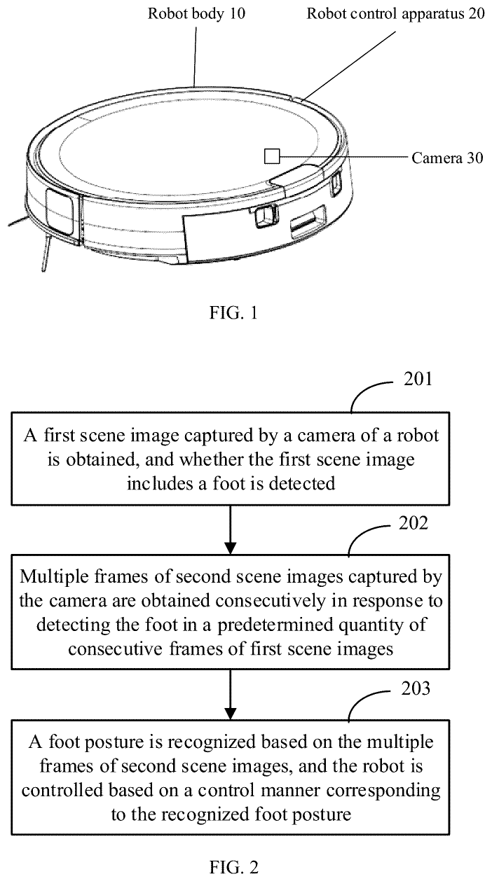

As illustrated in a schematic structural view of a robot in FIG. 1, the robot includes a robot body 10, a robot control apparatus 20, and a camera 30.

In particular, the robot body 10 is configured to move and is electrically connected to the robot control apparatus 20. The camera 30 is arranged at a side of the robot body 10 facing away from the ground. That is, the camera 30 is arranged directly in front of the robot. During a movement of the robot, the camera 30 may be controlled to take pictures of scenes in front of the robot to realize obstacle avoidance and path planning.

In one embodiment, the robot control apparatus 20 may be independent of the robot body 10 or, of course, may be integrated within the robot body 10. The present disclosure is not limited in this regard.

It should be noted that the robot body 10 is provided with structures such as a movement module, a control module, and various sensors, to realize environmental map construction and path planning for the robot.

Based on the above functional description of the respective structures, a control principle of the robot control device 20 is as follows. The first scene image captured by the camera of the robot is obtained. Whether the first scene image includes the foot is detected. The multiple frames of second scene images captured by the camera are obtained consecutively in response to detecting the foot in the predetermined quantity of consecutive frames of first scene images. Therefore, the foot posture is recognized based on the multiple frames of second scene images. The robot is controlled based on the control manner corresponding to the recognized foot posture.

The embodiments of the present disclosure will be described clearly and completely below in combination with accompanying drawings of the embodiments of the present disclosure.

### First Embodiment

FIG. 2 is a schematic flowchart illustrating a robot control method according to an exemplary embodiment of the present disclosure. The robot to which the robot control method is applicable includes the camera 30 as illustrated in FIG. 1. As an example, the robot is described below as a sweeping robot. As illustrated in FIG. 2, the robot control method includes the following operations at blocks 201 to 203.

At block 201, a first scene image captured by a camera of a robot is obtained, and whether the first scene image includes a foot is detected.

Whether the robot is in a movement state or a stopped state, scene images of the scene around the robot are captured in real time by the camera mounted at the robot. When a person accesses a field of view of the camera, only a foot of the person can be captured by the camera due to a limited height of the robot.

In one embodiment, for a process of detecting whether the first scene image includes the foot, the first scene image may be inputted into a trained first neural network model, the first neural network model being configured to detect whether the first scene image includes the foot, and output a detection result. Detecting whether the foot appears within the field of view using the neural network is simple and accurate.

Since the first neural network model only needs to determine whether a human foot appears in the image, a simple binary classification model may be adopted as the first neural network model.

In one embodiment, due to limited computing power of the robot itself, the binary classification model may be constructed using a deep convolutional network plus a small quantity of fully connected layers.

In this embodiment, the first neural network model needs to be pre-trained before being applied. A training process of the first neural network model includes: obtaining an image, captured by the camera, containing the foot as a positive sample, and obtaining an image, captured by the camera, without the foot as a negative sample; and obtaining the first neural network model by training a pre-established classification model using the positive sample and the negative sample.

During capturing of positive and negative samples, different persons wearing different shoes may make some predetermined postures with their feet within the field of view of the camera of the robot, which is captured by the camera into a video. Images containing the feet are taken from the video as positive samples, while images containing no feet are taken from the video as negative samples.

At block 202, multiple frames of second scene images captured by the camera are obtained consecutively in response to detecting the foot in a predetermined quantity of consecutive frames of first scene images.

By limiting that the foot posture is recognized subsequent to a detection of the foot in multiple consecutive frames of first scene images, a false detection or a user's unintentional entrance into the field of view of the camera can be avoided.

Further, since it takes a few seconds for a person to complete some specific foot postures, multiple consecutive frames of images need to be obtained for recognition of some specific foot postures.

It is conceivable for those skilled in the art that the above-mentioned “first scene image” and “second scene image” both belong to the scene images captured by the camera, except that the first scene image is captured earlier than the second scene image. That is, a specific foot posture recognition is performed only when the human foot is detected by the robot within the field of view of the camera.

At block 203, a foot posture is recognized based on the multiple frames of second scene images, and the robot is controlled based on a control manner corresponding to the recognized foot posture.

In one embodiment, for a recognition process of the foot posture, the multiple frames of second scene images that are obtained consecutively may be inputted into a trained second neural network model, and recognizing the foot posture by the second neural network model based on the multiple frames of second scene images.

For a specific process of recognizing the foot posture by the second neural network model, reference can be made to relevant description in the following embodiments, which will not be described in detail herein.

The second neural network model belongs to an action recognition model. The second neural network model needs to be pre-trained before being applied. The training process of the second neural network model includes: obtaining multiple video segments each containing the foot that are captured by the camera, and labeling a predetermined foot posture contained in each of the multiple video segments; and obtaining the second neural network model by training a pre-established action recognition model using multiple labeled video segments.

In one embodiment, during collection of training data, different persons wearing different shoes may make some predetermined postures with their feet within the field of view of the camera of the robot, which is captured by the camera into a video. Each video is labeled with a foot posture label.

Types of valid foot postures that can be recognized by the second neural network model may be set as desired. Assuming that the robot has four control functions, data sets containing four foot postures are collected to train the action recognition model during training of the second neural network model. Foot postures other than the four foot postures are recognized as invalid foot postures by the second neural network model.

In one embodiment, when four valid foot postures can be recognized by the second neural network model, for a process of controlling the robot based on the control manner corresponding to the recognized foot posture, the robot is controlled to initiate a cleaning mode to start cleaning, when the recognized foot posture is a first predetermined posture. When the recognized foot posture is a second predetermined posture, the robot is controlled to stop cleaning. When the recognized foot posture is a third predetermined posture, the robot is controlled to access a target-tracking mode, to enable the robot to track the user's foot and reach a specific position. When the recognized foot posture is a fourth predetermined posture, the robot is controlled to perform intensive cleaning in a predetermined range around a position of the foot.

It is conceivable for those skilled in the art that the above four control functions are only exemplary illustrations. The present disclosure includes, but is not limited to, the four functions such as start cleaning, stop cleaning, target tracking, and intensive cleaning.

It should be noted that since model parameters contained in each layer of the trained second neural network model are all of floating-point types but the robot has limited computing power, a problem of an extremely low operation efficiency occurs if the robot is equipped with a floating-point format model. To eliminate an effect on the operation efficiency of the robot, in the present disclosure, an integer quantization may be further performed on at least one model parameter of the second neural network model, subsequent to obtaining the second neural network model. Therefore, deploying the second neural network model, obtained after performing the integer quantization, to the robot can occupy less resources, realizing an efficient and stable recognition.

In one embodiment, a calculation formula for the integer quantization is as follows:

$$Q = R / S + Z ,$$

where Q represents a quantized integer parameter, R represents a parameter of floating-point type in the model, S=(Rmax−Rmin)/(Qmax−Qmin), which is a quantization scale, and Z=Qmax−Rmax/S, which is a zero point of quantization.

Based on the above-mentioned step 201 to step 203, in an embodiment, to minimize a resource occupation of the robot and ease an energy consumption burden, the complex second neural network model remains dormant, while only the simple first neural network model is run to detect whether the first scene image includes the foot. When the foot is detected in the multiple consecutive frames of first scene images, the second neural network model is woken up, to recognize the foot posture based on the multiple frames of second scene images that are further captured.

Further, when no valid foot posture is recognized by the second neural network model for a sustained period of time, the second neural network model is controlled to re-access a dormant state, and the first neural network model is activated.

Therefore, a control flow illustrated in FIG. 2 is completed. In the scene image captured by the camera mounted at the robot, when the foot is captured within the field of view of the robot, the specific foot posture is recognized using the video captured by the camera. Therefore, the intelligent control of the robot is realized based on the recognized foot posture. Compared with the conventional control method based on the application on the mobile phone or pressing the buttons on the machine body of the robot, the method provided in this disclosure is more convenient, efficient, and intelligent, which can greatly improve the user experience. In addition, since the intelligent control can be realized using the existing camera of the robot, the intelligent control of the product can be realized without additional costs, which further improves the user experience.

### Second Embodiment

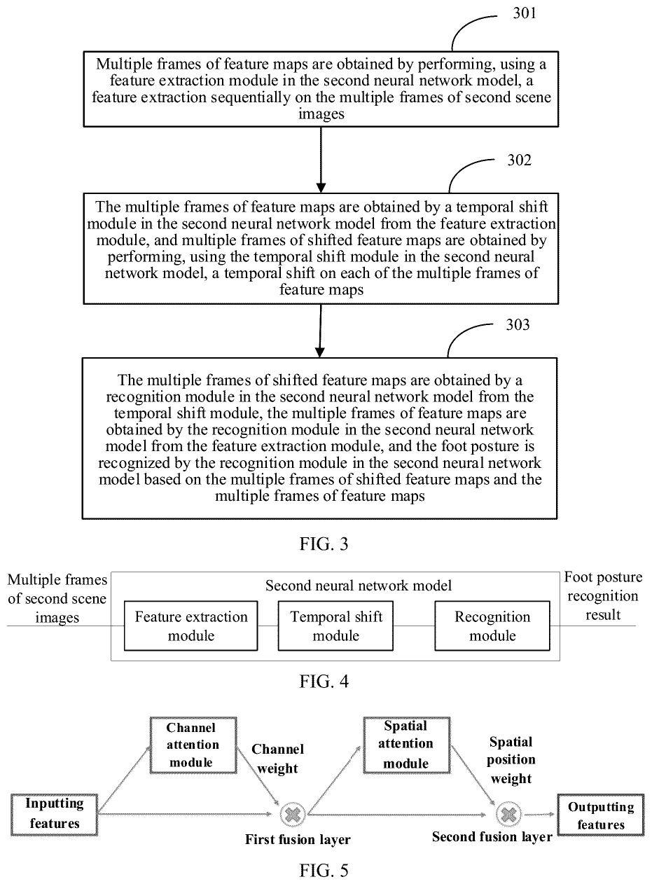

FIG. 3 is a schematic flowchart illustrating a foot posture recognition performed by the second neural network model according to the embodiment illustrated in FIG. 2 of the present disclosure. Based on the above-mentioned embodiment illustrated in FIG. 2 and in conjunction with a structure of the second neural network model illustrated in FIG. 4, a process of the foot posture recognition performed by the second neural network model includes the following operations at block.

At block 301, multiple frames of feature maps are obtained by performing, using a feature extraction module in the second neural network model, a feature extraction sequentially on the multiple frames of second scene images.

In one embodiment, the multiple frames of feature maps are obtained by performing, using a convolutional module with an attention enhancement mechanism in the feature extraction module, the feature extraction sequentially on the multiple frames of second scene images, in such a manner that the model can focus more on effective information.

The convolutional module includes multiple convolutional layers. The convolutional module with the attention enhancement mechanism includes an attention module arranged between at least one pair of adjacent convolutional layers. The attention module may be configured to calculate a channel weight and a spatial position weight based on input features, and then weigh the input features without changing shapes of the input features.

In one embodiment, as illustrated in FIG. 5, the attention module includes a channel attention module, a first fusion layer, a spatial attention module, and a second fusion layer. An operation principle of each module layer includes: obtaining, by the channel attention module, a channel weight based on a feature map outputted by a previous convolutional layer; obtaining a first fusion feature map by fusing, by the first fusion layer, the channel weight to the feature map outputted by the previous convolutional layer; obtaining, by the spatial attention module, a spatial position weight based on the first fusion feature map outputted by the first fusion layer; and obtaining a second fusion feature map by fusing, by the second fusion layer, the spatial position weight to the first fusion feature map, and inputting, by the second fusion layer, the second fusion feature map to a next convolutional layer.

A product operation is performed by both the first fusion layer and the second fusion layer. That is, a product operation is performed on the two pieces of input information.

At block 302, the multiple frames of feature maps are obtained by a temporal shift module in the second neural network model from the feature extraction module, and multiple frames of shifted feature maps are obtained by performing, using the temporal shift module in the second neural network model, a temporal shift on each of the multiple frames of feature maps.

Performing the temporal shift on each of the multiple frames of feature maps can effectively fuse temporal information between the multiple frames of feature maps without increasing computational effort, in such a manner that the shifted feature maps can obtain a temporal modeling ability.

In one embodiment, for each of frames of feature maps ranging from a first frame of feature map to a penultimate frame of feature map in the multiple frames of feature maps, features of part of channels in the feature map are shifted to corresponding channels of a successively subsequent frame of feature map to obtain the multiple frames of shifted feature maps.

To ensure that the multiple frames of shifted feature maps are consistent in size, a feature of a removed channel in the first frame of feature map may be set as 0.

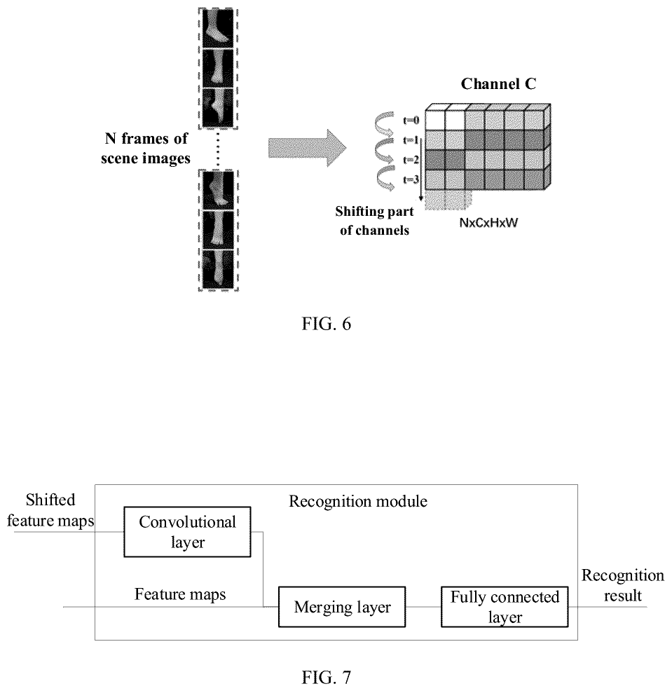

Based on a temporal shift principle illustrated in FIG. 6, a feature map of NxCxHxW is inputted (N represents a picture serial number, C represents a quantity of channels, H represents a height of a feature map, and W represents a width of the feature map). When N=4, for a feature map of t=4, features of part of channels in the feature map of t=4 are discarded, and features of corresponding channels in a feature map of t=3 are shifted to the feature map of t=4. For the feature map of t=3, features of part of channels in a feature map of t=2 are shifted to the feature map of t=3. For the feature map of t=2, features of part of channels in a feature map of t=1 are shifted to the feature map of t=2. For the feature map of t=1, features of part of channels in a feature map of t=0 are shifted to the feature map of t=1.

At block 303, the multiple frames of shifted feature maps are obtained by a recognition module in the second neural network model from the temporal shift module, the multiple frames of feature maps are obtained by the recognition module in the second neural network model from the feature extraction module, and the foot posture is recognized by the recognition module in the second neural network model based on the multiple frames of shifted feature maps and the multiple frames of feature maps.

In one embodiment, a recognition process of a structure of a recognition module illustrated in FIG. 7 includes the following steps.

1. A convolution operation is performed by a convolutional layer in the recognition module on each of the multiple frames of shifted feature maps, to fuse a shifted previous temporal feature with a current temporal feature. It should be noted that to ensure subsequent merging between each of the multiple frames of shifted feature maps and the feature map outputted by the feature extraction module, the quantity of channels and the size of the feature map outputted subsequent to convolution should be guaranteed to remain unchanged during a convolutional operation.

2. Each of multiple frames of convolved feature maps is obtained by a merging layer in the recognition module from the convolutional layer. Multiple frames of merged feature maps are obtained by merging, by the merging layer in the recognition module, each of the multiple frames of convolved feature maps with a corresponding one of the multiple frames of feature maps outputted by the feature extraction module. Since temporal modeling information across frames is contained in the convolved feature map and spatial modeling information is retained by the feature extraction module, merging the convolved feature map with the feature map outputted by the feature extraction module allows the merged feature map to have both temporal modeling information and spatial modeling information. Specifically, a merge operation performed on the merging layer is a feature addition operation.

3. The multiple frames of merged feature maps are obtained by a fully connected layer in the recognition module from the merging layer, and a foot posture recognition result is obtained by the fully connected layer in the recognition module based on the multiple frames of merged feature maps.

The foot posture recognition result outputted by the fully connected layer may be a serial number of a valid foot posture or a serial number of an invalid foot posture.

The valid foot posture refers to a foot posture that can be recognized by the recognition module. The invalid foot posture refers to a foot posture that cannot be recognized by the recognition module.

Therefore, a recognition process illustrated in FIG. 3 is completed. By adding the temporal shift module to the model, each frame of feature map has a temporal modeling capability, which improves a video understanding capability. Therefore, specific foot postures can be accurately recognized.

### Third Embodiment

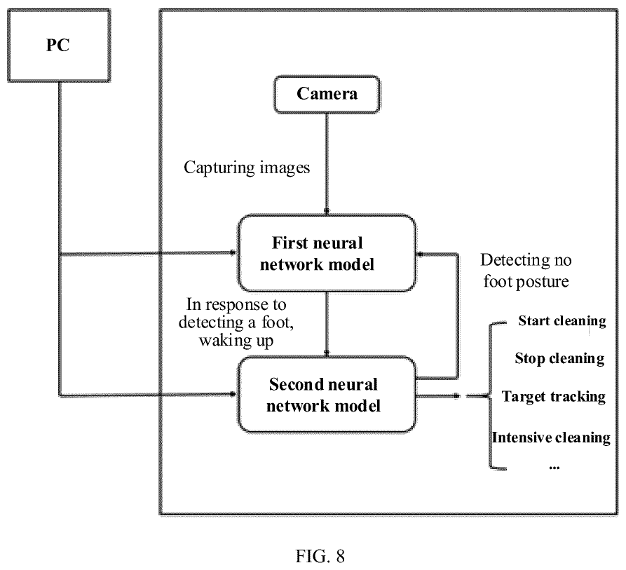

FIG. 8 is a specific flowchart illustrating a robot control method according to an exemplary embodiment of the present disclosure. Based on the above-mentioned embodiments illustrated in FIG. 2 to FIG. 7, the specific flowchart includes the following contents. After the first neural network model and the second neural network model are trained on a PC, the first neural network model and the second neural network model are deployed to the robot. The scene image is captured by the camera mounted at the robot in real time, and inputted into the first neural network model for the first neural network model to detect whether the input scene image includes the foot. When the foot is detected in the multiple consecutive frames of scene images, the second neural network model is woken up, and the video captured by the camera is inputted into the second neural network model for the second neural network model to recognize the foot posture in the input video. Therefore, the robot is controlled based on the control manner corresponding to the recognized foot posture (for example, functions such as controlling the robot to start cleaning, stop cleaning, perform target tracking, and perform intensive cleaning).

Further, when no valid foot posture is recognized by the second neural network model for a sustained period of time, the second neural network model is controlled to re-access the dormant state, and the first neural network model is activated to continue a foot detection.

According to the embodiments of the present disclosure, a robot control apparatus corresponding to the robot control method according to the above-mentioned embodiments is further provided to execute the robot control method described above.

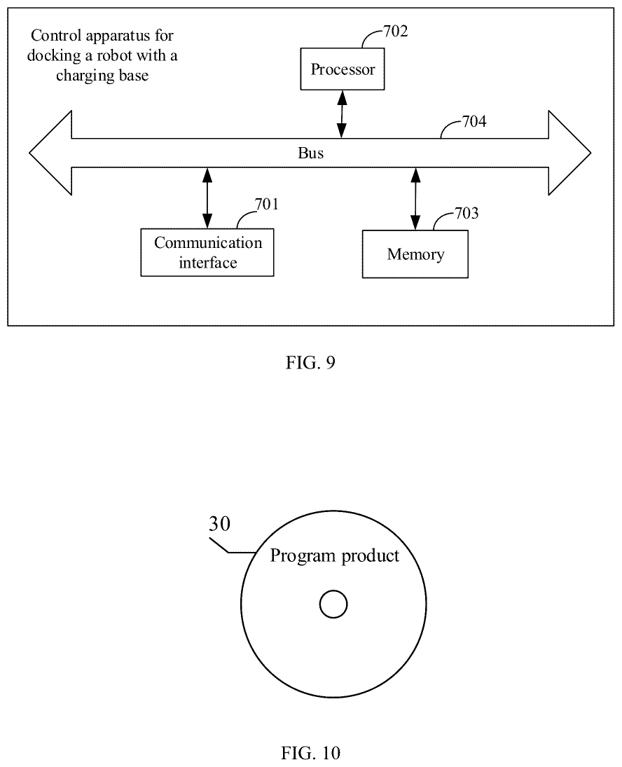

FIG. 9 is a schematic structural diagram of a robot control apparatus according to an exemplary embodiment of the present disclosure. The robot control apparatus includes a communication interface 701, a processor 702, a memory 703, and a bus 704. The communication interface 701, the processor 702, and the memory 703 are in communication with each other via the bus 704. The processor 702 is capable of performing the above robot control method through reading and executing machine-executable instructions in the memory 703 and corresponding to control logic of the robot control method. Details of the method can be found in the above-mentioned embodiments and thus will not be repeated herein.

The memory 703 referred to in the present disclosure may be any electronic, magnetic, optical, or other physical storage devices, and may contain storage information such as executable instructions or data. Specifically, the memory 703 may be a Random Access Memory (RAM), a flash memory, a storage drive (e.g., a hard disk drive), any type of storage disk (e.g., an optical disc, a Digital Versatile Disc (DVD), etc.), or a similar storage medium, or a combination thereof. A communication connection between one system network element and at least one other network element is realized by at least one communication interface 701 (which may be a wired or wireless communication interface), using networks such as the Internet, Wide Area Network (WAN), Local Area Network (LAN), and Metropolitan Area Network (MAN).

The bus 704 may be an Industry Standard Architecture (ISA) bus, a Peripheral Component Interconnect (PCI) bus, an Extended Industry Standard Architecture (EISA) bus, etc. The bus may be classified into an address bus, a data bus, a control bus, etc. The memory 703 is configured to store a program. The processor 702 is configured to execute the program subsequent to a reception of an execution instruction.

The processor 702 may be an integrated circuit chip having signal processing capabilities. In an implementation, actions of the above method may be accomplished by an integrated logic circuit in hardware in the processor 702 or by instructions in the form of software. The above processor 702 may be a general-purpose processor, including a Central Processing Unit (CPU), a Network Processor (NP), etc.; and may further be a Digital Signal Processor (DSP), an Application Specific Integrated Circuit (ASIC), a Field-Programmable Gate Array (FPGA) or other programmable logic devices, a discrete gate or a transistor logic device, and a discrete hardware component. The method, actions, and logic block diagrams according to any of the embodiments of the present disclosure may be implemented or performed. The general-purpose processor may be a microprocessor, or the processor may further be any conventional processor, etc. The actions of the method disclosed in combination with any of the embodiments of the present disclosure may be directly embodied as performed by a hardware decoding processor or performed by a combination of a hardware module and a software module in a decoding processor.

The robot control apparatus according to the embodiments of the present disclosure is of the same concept as the robot control method according to the embodiments of the present disclosure and therefore provides the same advantageous effect as the robot control method adopted, performed, or implemented by the robot control apparatus.

According to the embodiment of the present disclosure, a computer-readable storage medium corresponding to the robot control method according to any of the above-mentioned embodiments is further provided. As illustrated in FIG. 10, the computer-readable storage medium is an optical disc 30. The optical disc 30 has a computer program (i.e., a program product) stored thereon. The computer program, when executed by the processor, performs the robot control method according to any of the above-mentioned embodiments.

It should be noted that examples of the computer-readable storage medium may also include, but are not limited to, a Phase-Change Memory (PRAM), a Static RAM (SRAM), a Dynamic RAM (DRAM), other types of RAMs, a Read-Only Memory (ROM), an Electrically Erasable Programmable Read-Only Memory (EEPROM), a flash memory or other optical or magnetic storage media. Details thereof will be omitted here.

The computer-readable storage medium according to the embodiments of the present disclosure is of the same concept as the robot control method according to the embodiments of the present disclosure and therefore provides the same advantageous effect as the robot control method adopted, performed, or implemented by an application stored on the computer-readable storage medium.

The present disclosure is intended to encompass any variations, uses, or adaptations of the present disclosure, which follow the general principles of the present disclosure and include common knowledge or conventional means in the art that are not disclosed here. The description and embodiments are to be considered exemplary only, and the real scope and the essence of the present disclosure are defined by the claims as attached.

1. A robot control method, comprising:
obtaining a first scene image captured by a camera of a robot, and detecting whether the first scene image comprises a foot;
obtaining a plurality of frames of second scene images captured by the camera consecutively in response to detecting the foot in a predetermined quantity of consecutive frames of first scene images; and
recognizing a foot posture based on the plurality of frames of second scene images, and controlling the robot based on a control manner corresponding to the recognized foot posture.

2. The method according to claim 1, wherein the detecting whether the first scene image comprises the foot comprises:
inputting the first scene image into a trained first neural network model, the first neural network model being configured to detect whether the first scene image comprises the foot, and output a detection result.

3. The method according to claim 2, further comprising a training process of the first neural network model, the training process comprising:
obtaining an image, captured by the camera, containing the foot as a positive sample;
obtaining an image, captured by the camera, without the foot as a negative sample; and
obtaining the first neural network model by training a pre-established classification model using the positive sample and the negative sample.

4. The method according to claim 1, wherein the recognizing the foot posture based on the plurality of frames of second scene images comprises:
inputting the plurality of frames of second scene images that are obtained consecutively into a trained second neural network model, and recognizing the foot posture by the second neural network model based on the plurality of frames of second scene images.

5. The method according to claim 4, wherein the recognizing the foot posture by the second neural network model based on the plurality of frames of second scene images comprises:
obtaining a plurality of frames of feature maps by performing, using a feature extraction module in the second neural network model, a feature extraction sequentially on the plurality of frames of second scene images;
obtaining, by a temporal shift module in the second neural network model, the plurality of frames of feature maps from the feature extraction module, and obtaining a plurality of frames of shifted feature maps by performing, using the temporal shift module in the second neural network model, a temporal shift on each of the plurality of frames of feature maps; and
obtaining, by a recognition module in the second neural network model, the plurality of frames of shifted feature maps from the temporal shift module and the plurality of frames of feature maps from the feature extraction module, and recognizing, by the recognition module in the second neural network model, the foot posture based on the plurality of frames of shifted feature maps and the plurality of frames of feature maps.

6. The method according to claim 5, wherein the obtaining the plurality of frames of shifted feature maps by performing, using the temporal shift module in the second neural network model, the temporal shift on each of the plurality of frames of feature maps comprises:
for each of frames of feature maps ranging from a first frame of feature map to a penultimate frame of feature map in the plurality of frames of feature maps, shifting features of part of channels in the feature map to corresponding channels of a successively subsequent frame of feature map to obtain the plurality of frames of shifted feature maps.

7. The method according to claim 5, wherein the recognizing, by the recognition module in the second neural network model, the foot posture based on the plurality of frames of shifted feature maps and the plurality of frames of feature maps comprises:
performing, by a convolutional layer in the recognition module, a convolution operation on each of the plurality of frames of shifted feature maps;
obtaining, by a merging layer in the recognition module, each of a plurality of frames of convolved feature maps from the convolutional layer, and obtaining a plurality of frames of merged feature maps by merging, by the merging layer in the recognition module, each of the plurality of frames of convolved feature maps with a corresponding one of the plurality of frames of feature maps; and
obtaining, by a fully connected layer in the recognition module, the plurality of frames of merged feature maps from the merging layer, and obtaining, by the fully connected layer in the recognition module, a foot posture recognition result based on the plurality of frames of merged feature maps.

8. The method according to claim 5, wherein the obtaining the plurality of frames of feature maps by performing, using the feature extraction module in the second neural network model, the feature extraction sequentially on the plurality of frames of second scene images comprises:
obtaining the plurality of frames of feature maps by performing, using a convolutional module with an attention enhancement mechanism in the feature extraction module, the feature extraction sequentially on the plurality of frames of second scene images.

9. The method according to claim 8, wherein the convolutional module with the attention enhancement mechanism comprises an attention module arranged between at least one pair of adjacent convolutional layers, the attention module comprising a channel attention module, a first fusion layer, a spatial attention module, and a second fusion layer; and
wherein the method further comprises:
obtaining, by the channel attention module, a channel weight based on a feature map output by a previous convolutional layer;
obtaining a first fusion feature map by fusing, by the first fusion layer, the channel weight to the feature map outputted by the previous convolutional layer;
obtaining, by the spatial attention module, a spatial position weight based on the first fusion feature map outputted by the first fusion layer; and
obtaining a second fusion feature map by fusing, by the second fusion layer, the spatial position weight to the first fusion feature map, and inputting, by the second fusion layer, the second fusion feature map to a next convolutional layer.

10. The method according to claim 4, further comprising a training process of the second neural network model, the training process comprising:
obtaining a plurality of video segments each containing the foot that are captured by the camera, and labeling a predetermined foot posture contained in each of the plurality of video segments; and
obtaining the second neural network model by training a pre-established action recognition model using a plurality of labeled video segments.

11. The method according to claim 10, subsequent to the obtaining the second neural network model, the method further comprising:
performing an integer quantization on at least one model parameter of the second neural network model.

12. The method according to claim 1, wherein the controlling the robot based on the control manner corresponding to the recognized foot posture comprises:
controlling, based on the recognized foot posture being a first predetermined posture, the robot to initiate a cleaning mode to start cleaning;
controlling, based on the recognized foot posture being a second predetermined posture, the robot to stop cleaning;
controlling, based on the recognized foot posture being a third predetermined posture, the robot to access a target-tracking mode; and
controlling, based on the recognized foot posture being a fourth predetermined posture, the robot to perform cleaning in a predetermined range around a position of the foot.

13. A robot control apparatus, comprising:
a memory;
a processor; and
a computer program stored on the memory and executable on the processor,
wherein the processor is configured to implement, when executing the computer program, steps of the method according to claim 1.

14. A robot, comprising:
the robot control apparatus according to claim 13; and
a camera configured to capture a scene image of the robot.

15. A computer-readable storage medium having a computer program stored thereon, wherein the program, when executed by a processor, cause the processor to:
obtain a first scene image captured by a camera of a robot, and detecting whether the first scene image comprises a foot;
obtain a plurality of frames of second scene images captured by the camera consecutively in response to detecting the foot in a predetermined quantity of consecutive frames of first scene images; and
recognize a foot posture based on the plurality of frames of second scene images, and controlling the robot based on a control manner corresponding to the recognized foot posture.

16. The computer-readable storage medium according to claim 15, wherein the detecting whether the first scene image comprises the foot comprises:
inputting the first scene image into a trained first neural network model, the first neural network model being configured to detect whether the first scene image comprises the foot, and output a detection result.

17. The computer-readable storage medium according to claim 16, further comprising a training process of the first neural network model, the training process comprising:
obtaining an image, captured by the camera, containing the foot as a positive sample;
obtaining an image, captured by the camera, without the foot as a negative sample; and
obtaining the first neural network model by training a pre-established classification model using the positive sample and the negative sample.

18. The computer-readable storage medium according to claim 15, wherein the recognizing the foot posture based on the plurality of frames of second scene images comprises:
inputting the plurality of frames of second scene images that are obtained consecutively into a trained second neural network model, and recognizing the foot posture by the second neural network model based on the plurality of frames of second scene images.

19. The computer-readable storage medium according to claim 18, wherein the recognizing the foot posture by the second neural network model based on the plurality of frames of second scene images comprises:
obtaining a plurality of frames of feature maps by performing, using a feature extraction module in the second neural network model, a feature extraction sequentially on the plurality of frames of second scene images;
obtaining, by a temporal shift module in the second neural network model, the plurality of frames of feature maps from the feature extraction module, and obtaining a plurality of frames of shifted feature maps by performing, using the temporal shift module in the second neural network model, a temporal shift on each of the plurality of frames of feature maps; and
obtaining, by a recognition module in the second neural network model, the plurality of frames of shifted feature maps from the temporal shift module and the plurality of frames of feature maps from the feature extraction module, and recognizing, by the recognition module in the second neural network model, the foot posture based on the plurality of frames of shifted feature maps and the plurality of frames of feature maps.

20. The computer-readable storage medium according to claim 19, wherein the obtaining the plurality of frames of shifted feature maps by performing, using the temporal shift module in the second neural network model, the temporal shift on each of the plurality of frames of feature maps comprises:
for each of frames of feature maps ranging from a first frame of feature map to a penultimate frame of feature map in the plurality of frames of feature maps, shifting features of part of channels in the feature map to corresponding channels of a successively subsequent frame of feature map to obtain the plurality of frames of shifted feature maps.
